(19) United States
(12) Patent Application Publication
(10) Pub. No.: US 2023/0074042 A1
(43) Pub. Date: Mar. 9, 2023

(54) INSPECTION ROUTE PLAN PROPOSAL SYSTEM AND INSPECTION ROUTE PLAN PROPOSAL METHOD

(71) Applicant: MITSUBISHI HEAVY INDUSTRIES, LTD., Tokyo (JP)

(72) Inventors: Masaki HONDA, Tokyo (JP); Gen SAKASHITA, Tokyo (JP); Tomohiro HIGUCHI, Tokyo (JP)

(73) Assignee: MITSUBISHI HEAVY INDUSTRIES, LTD., Tokyo (JP)

(21) Appl. No.: 17/899,927

(22) Filed: Aug. 31, 2022

(30) Foreign Application Priority Data
Sep. 9, 2021 (JP) 2021-146751

(51) Int. Cl. G06Q 10/04; G06Q 10/06

(52) U.S. Cl. CPC G06Q 10/047; G06Q 10/06316

(57) ABSTRACT

An inspection route plan proposal system includes: a damage risk calculation unit configured to calculate a damage risk for each of a plurality of apparatuses based on an inspection result for each of the plurality of apparatuses; an inspection required time calculation unit configured to calculate an inspection required time for each of the inspection items of each of the plurality of apparatuses based on the inspection work time for each of the inspection items of each of the plurality of apparatuses; and an inspection route plan presentation unit that presents an inspection route plan including an inspection target apparatus, an inspection execution item, and a total inspection required time required to execute inspection of the inspection execution item, the inspection route plan presentation unit being configured to be able to present a plurality of the inspection route plans, each inspection route plan having at least one of the inspection target apparatuses or at least one of the inspection execution items being different.

### CROSS-REFERENCE TO RELATED APPLICATIONS

This application claims the benefit of priority to Japanese Patent Application Number 2021-146751 filed on Sep. 9, 2021. The entire contents of the above-identified application are hereby incorporated by reference.

### TECHNICAL FIELD

The disclosure relates to an inspection route plan proposal system and an inspection route plan proposal method for proposing an inspection route plan for inspecting a plurality of apparatuses installed in a target inspection area.

### RELATED ART

For example, patrol inspection in a plant such as a thermal power plant includes various types of work such as tactile work, reading meters such an analog meters, detecting abnormal sounds, and checking for steam leakage. There is a case where such tasks need to be performed several times in turn every day, and in a case where the work is performed by a patrol staff member (person), there are problems such as increase in inspection cost and shortage of labor. As a measure for reducing the inspection cost in patrol inspection, an attempt has been made to digitize the measurement values of analog meters and other devices by using wireless sensors and transmit the digitized measurement values to a mobile terminal possessed by a patrol staff member via wireless communication with the wireless sensors.

Japanese Patent Application Laid-Open No. 2006-350604 discloses a system that optimizes an inspection route so as to additionally inspect an apparatus outside the inspection route by referring to maintenance management history information or the like when acquiring abnormality or caution information of the apparatus in a prescribed inspection route in a site patrol inspection of a plant using a mobile terminal.

### SUMMARY

In the system described in Japanese Patent Application Laid-Open No. 2006-350604, when an abnormality of the apparatus is determined, the apparatus to be additionally inspected is added to the inspection route, which leads to an improvement in the reliability of the plant, but there is a possibility that the workload increases and the human resource shortage problem deteriorates. As described above, in the patrol inspection of plants in recent years, since there is a case where apparatuses to be inspected are added to the inspection route, there is a possibility that the inspection cost increases as apparatuses to be inspection targets are added. If the number of apparatuses to be inspection targets in the patrol inspection is simply reduced in order to reduce the inspection cost, there is a possibility that appropriate inspection is not performed on the apparatuses and the reliability of the plant is lowered.

In view of the above circumstances, an object of at least one embodiment of the disclosure is to provide an inspection route plan proposal system and an inspection route plan proposal method capable of proposing an inspection route plan capable of intensively inspecting apparatuses having a damage risk that is high and reducing excessive inspection costs.

An inspection route plan proposal system according to one embodiment of the disclosure is an inspection route plan proposal system for proposing an inspection route plan for inspecting a plurality of apparatuses installed in a target inspection area, the inspection route plan proposal system including: an inspection result information storage unit configured to store an inspection result for each of the plurality of apparatuses and an inspection work time for each inspection item; a damage risk calculation unit configured to calculate a damage risk for each of the plurality of apparatuses based on the inspection results stored in the inspection result information storage unit; an inspection required time calculation unit configured to calculate an inspection required time for each of the inspection items of each of the plurality of apparatuses based on the inspection work times stored in the inspection result information storage unit; and an inspection route plan presentation unit that presents an inspection route plan including one or more inspection target apparatuses being an inspection target among the plurality of apparatuses, one or more inspection execution items being the inspection item to be executed on the inspection target apparatus, and a total inspection required time required to execute inspection of the inspection execution item on the one or more inspection target apparatuses, the inspection route plan presentation unit being configured to be able to present a plurality of the inspection route plans, each inspection route plan having at least one of the inspection target apparatuses or at least one of the inspection execution items being different, taking into account the damage risk and the inspection required time.

An inspection route plan proposal method according to one embodiment of the disclosure is an inspection route plan proposal method for proposing an inspection route plan for inspecting a plurality of apparatuses installed in a target inspection area, the inspection route plan proposal method including: an inspection result information acquisition step of acquiring an inspection result for each of the plurality of apparatuses and an inspection work time for each inspection item; a damage risk calculation step of calculating a damage risk for each of the plurality of apparatuses based on the inspection result acquired in the inspection result information acquisition step; an inspection required time calculation step of calculating an inspection required time for each of the inspection items of each of the plurality of apparatuses based on the inspection work time acquired in the inspection result information acquisition step; and an inspection route plan presentation step of presenting an inspection route plan including one or more inspection target apparatuses being an inspection target among the plurality of apparatuses, one or more inspection execution items being the inspection item to be executed on the inspection target apparatus, and a total inspection required time required to execute inspection of the inspection execution item on the one or more inspection target apparatuses, the inspection route plan presentation step of presenting a plurality of the inspection route plans, each inspection route plan having at least one of the inspection target apparatuses or at least one of the inspection execution items being different, taking into account the damage risk and the inspection required time.

According to at least one embodiment of the disclosure, an inspection route plan proposal system and an inspection route plan proposal method capable of proposing an inspection route plan capable of intensively inspecting an apparatus having a damage risk that is high and reducing an excessive inspection cost are provided.

### BRIEF DESCRIPTION OF DRAWINGS

The disclosure will be described with reference to the accompanying drawings, wherein like numbers reference like elements.

FIG. 1 is a flowchart of an inspection route plan proposal method according to one embodiment of the disclosure.

FIG. 2 is a schematic configuration diagram schematically illustrating a configuration of an inspection route plan proposal according to one embodiment of the disclosure.

FIG. 3 is an explanatory diagram for explaining an inspection route plan according to one embodiment of the disclosure.

FIG. 4 is a flowchart of a creation method of an inspection route plan.

FIG. 5 is an explanatory diagram for explaining an example of a creation method of an inspection route plan.

FIG. 6 is an explanatory diagram for explaining an inspection route plan according to one embodiment of the disclosure.

FIG. 7 is an explanatory diagram for explaining an example of a creation method of an inspection route plan.

FIG. 8 is an explanatory diagram for explaining information regarding an inspector.

FIG. 9 is a schematic configuration diagram schematically illustrating a configuration of an inspection route plan proposal according to one embodiment of the disclosure.

FIG. 10 is a flowchart of an inspection route plan proposal method according to one embodiment of the disclosure.

FIG. 11 is an explanatory diagram for explaining an update of an inspection route plan at the time of abnormality determination.

FIG. 12 is an explanatory diagram for explaining an update of an inspection route plan at the time of abnormality determination.

FIG. 13 is an explanatory diagram for explaining an update of an inspection route plan at the time of abnormality determination.

FIG. 14 is a flowchart of an inspection route plan proposal method according to one embodiment of the disclosure.

### DESCRIPTION OF EMBODIMENTS

Hereinafter, some embodiments of the disclosure will be described with reference to the accompanying drawings. However, the dimensions, materials, shapes, relative dispositions, or the like of components described in the embodiments or illustrated in the drawings are not intended to limit the scope of the disclosure and are merely illustrative examples.

For example, expressions indicating relative or absolute disposition such as “in a direction,” “along a direction,” “parallel,” “orthogonal,” “center,” “concentric,” or “coaxial” shall not be construed as indicating only such disposition in a strict literal sense but also as indicating a state of being relatively displaced by a tolerance, or by an angle or a distance as long as the same function can be obtained.

For example, expressions indicating a state of being equal such as “same,” “equal,” or “uniform” shall not be construed as indicating only a state of being strictly equal but also as indicating a state in which there is a tolerance or a difference as long as the same function can be obtained.

For example, expressions indicating a shape such as a rectangular shape or a cylindrical shape shall not be construed as only indicating a shape such as a rectangular shape or a cylindrical shape in a strict geometrical sense but also as indicating a shape including depressions, protrusions, chamfered corners, or the like as long as the same effect can be obtained.

On the other hand, expressions such as “comprising,” “including,” or “having” one component are not intended as exclusive expressions that exclude the presence of other components.

Note that the same reference signs may be assigned to similar configurations, with descriptions thereof being omitted.

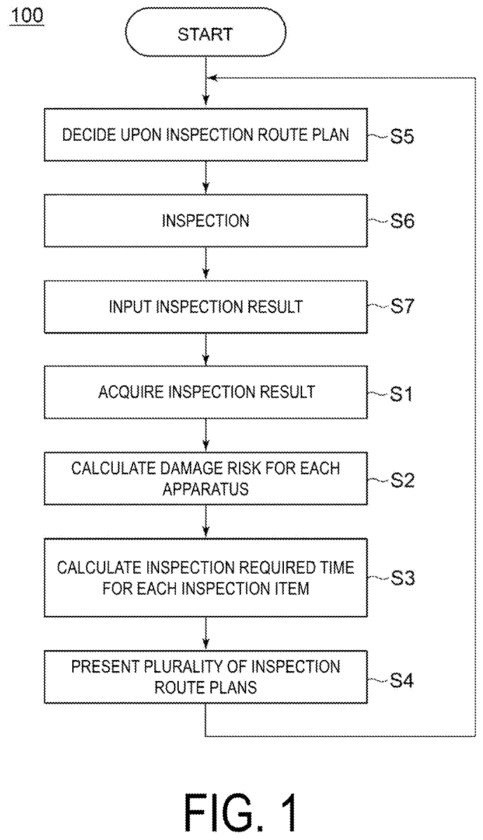

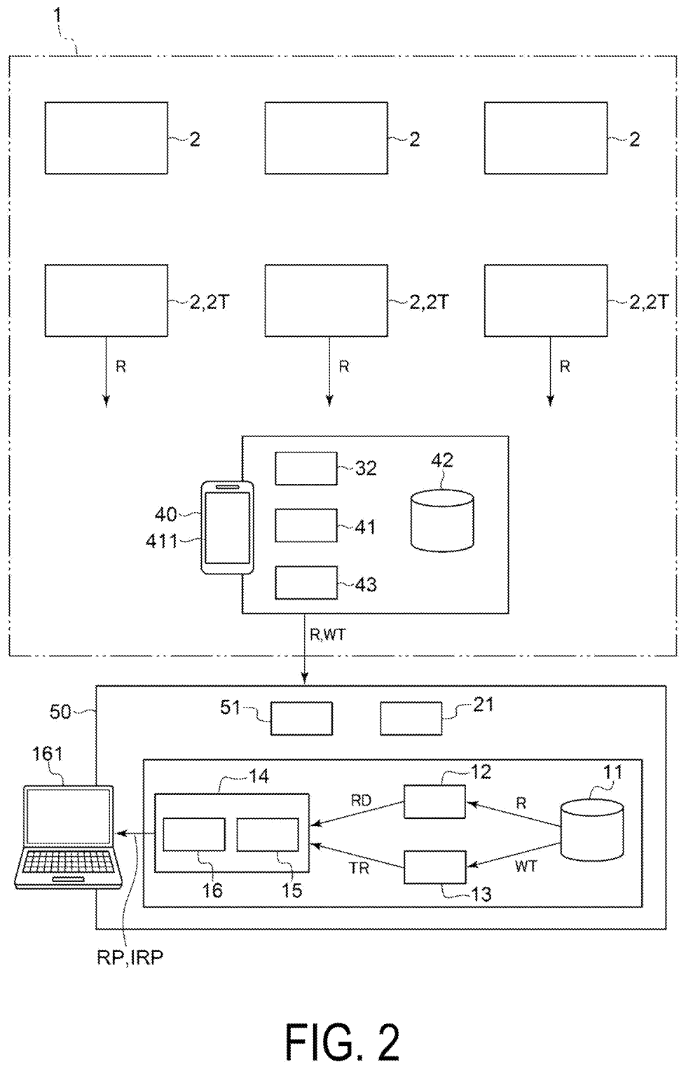

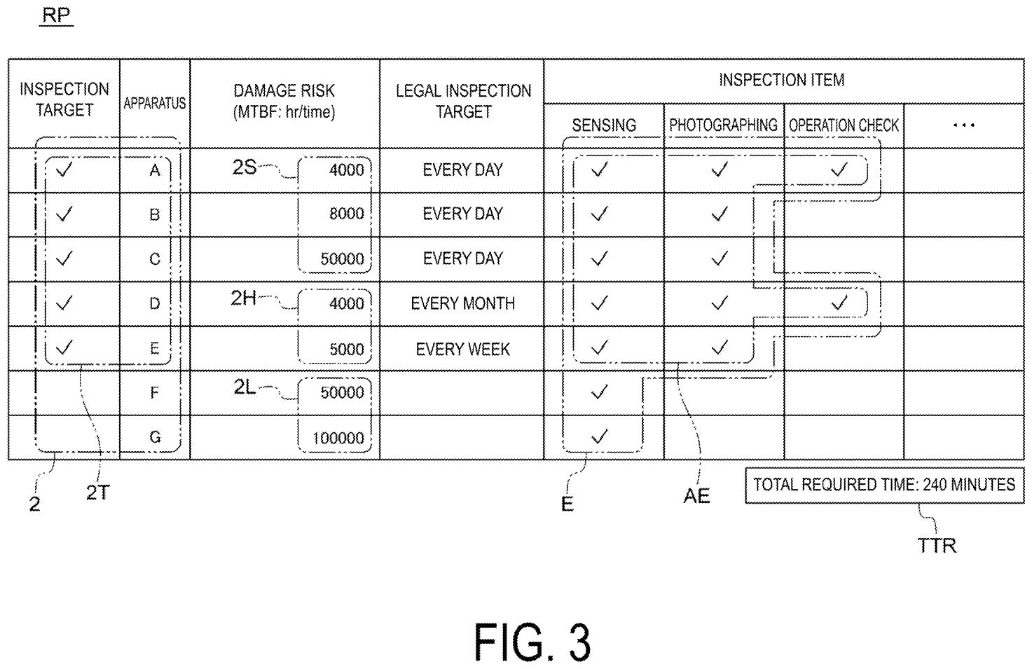

FIG. 1 is a flowchart of an inspection route plan proposal method according to one embodiment of the disclosure. FIG. 2 is a schematic configuration diagram schematically illustrating the configuration of an inspection route plan proposal according to one embodiment of the disclosure. FIG. 3 is an explanatory diagram for explaining an inspection route plan according to one embodiment of the disclosure.

### Inspection Route Plan Proposal Method

An inspection route plan proposal method 100 according to some embodiments is a method for proposing an inspection route plan RP for inspecting a plurality of apparatuses 2 (see FIG. 2) installed in a target inspection area 1. As illustrated in FIG. 1, the inspection route plan proposal method 100 includes at least an inspection result information acquisition step S1, a damage risk calculation step S2, an inspection required time calculation step S3, and an inspection route plan presentation step S4. As illustrated in FIG. 1, the inspection route plan proposal method 100 may further include an inspection route plan decision step S5, an inspection step S6, and an inspection result information input step S7. Hereinafter, a case where the plurality of apparatuses 2 include plant apparatuses constituting a plant (factory facility) and the target inspection area 1 includes the site of the plant will be described as an example.

At least one step in the inspection route plan proposal method 100 may be performed by an inspection route plan proposal system 10 (see FIG. 2), may be performed by a device or an apparatus other than the inspection route plan proposal system 10, or may be performed manually.

As illustrated in FIG. 3, the inspection route plan RP includes one or more inspection target apparatuses 2T being an inspection target among the plurality of apparatuses 2 installed in the target inspection area 1, one or more inspection execution items AE being an inspection item E to be executed on the inspection target apparatus 2T, and a total inspection required time TTR required to execute inspection of the inspection execution items AE on the one or more inspection target apparatuses 2T. The total inspection required time TTR is a time required to execute inspection on all the inspection execution items AE included in the inspection route plan RP, and is obtained by adding up the inspection required times TR of all the inspection execution items AE included in the inspection route plan RP.

As illustrated in FIG. 3, the inspection items E include sensing of the apparatus 2, photographing of the apparatus 2, and checking the operation of the apparatus 2.

In the inspection route plan decision step S5, a decision regarding the inspection route plan RP (the inspection target apparatuses 2T and the inspection execution items AE) is performed. In the inspection step S6, an inspection is performed in accordance with the inspection route plan RP decided upon in the inspection route plan decision step S5. That is, in the inspection step S6, the inspection of the inspection execution item AE is executed on the inspection target apparatus 2T included in the inspection route plan RP. The inspection in the inspection step S6 gives inspection results R for the inspection target apparatus 2T. The inspection results R include a determination result as to whether the inspection target apparatus 2T is normal or abnormal.

In the inspection result information input step S7, input of an inspection work time WT for each of the inspection results R and the inspection execution items AE (inspection items E) of one or more inspection target apparatuses 2T (apparatus 2) obtained by the inspection in the inspection step S6 is performed. Input of the inspection results R and the inspection work times WT may be performed by the inspector who executed the inspection in the inspection step S6.

The inspection results R and the inspection work times WT input in the inspection result information input step S7 are stored in an inspection result information storage unit 11. By repeatedly performing the steps from the inspection route plan decision step S5 to the inspection result information input step S7, the inspection result information storage unit 11 accumulates the inspection results R of the plurality of apparatuses 2 installed in the target inspection area 1 and the inspection work times WT for the inspection items E. Due to this, the inspection result information storage unit 11 stores the inspection results R of the plurality of apparatuses 2 and the inspection work times WT for the inspection items E.

In the inspection result information acquisition step S1, acquisition of the inspection results R of the plurality of apparatuses 2 and the inspection work times WT for the inspection items is performed. The inspection results R and the inspection work times WT are acquired from the inspection result information storage unit 11.

In the damage risk calculation step S2, based on the inspection results R acquired in the inspection result information acquisition step S1, calculation of a damage risk RD (in the illustrated example, a mean time between failures MTBF) for each of the plurality of apparatuses 2 is performed. In the illustrated embodiment, the damage risk calculation step S2 is performed by a damage risk calculation unit 12. The damage risk calculation unit 12 is configured to calculate the damage risk RD (in the illustrated example, the mean time between failures MTBF) for each of the plurality of apparatuses 2 based on the inspection results R stored in the inspection result information storage unit 11.

The damage risk calculation unit 12 calculates the damage risk RD (mean time between failures MTBF) for each of the plurality of apparatuses 2 by performing statistical processing on the inspection results R. Examples of the damage risk RD include the mean time between failures MTBF, which is a mean interval from one failure to the next failure of the apparatus 2, as illustrated in FIG. 3, and a failure frequency rate, which is the reciprocal of the mean time between failures MTBF. The apparatuses 2 having a short mean time between failures MTBF have a damage risk RD that is high, and the apparatuses 2 having a long mean time between failures MTBF have a damage risk RD that is low.

In the inspection required time calculation step S3, calculation of the inspection required time TR for each inspection item E of each of the plurality of apparatuses 2 is performed based on the inspection work times WT acquired in the inspection result information acquisition step S1. In the illustrated embodiment, the inspection required time calculation step S3 is performed by an inspection required time calculation unit 13. The inspection required time calculation unit 13 is configured to calculate the inspection required time TR for each inspection item E of each of the plurality of apparatuses 2 based on the inspection work times WT stored in the inspection result information storage unit 11.

By performing statistical processing on the inspection work times WT for the inspection items E of the plurality of apparatuses 2, the inspection required time calculation unit 13 calculates the inspection required time TR for each inspection item E of each of the plurality of apparatuses 2. For example, the inspection required time calculation unit 13 may set a mean value or a median value of the inspection work times WT as the inspection required time TR.

In the inspection route plan presentation step S4, presentation of a plurality of the inspection route plans RP is performed taking into account the damage risk RD and the inspection required time TR. In each inspection route plan RP, at least one of the inspection target apparatuses 2T or at least one of the inspection execution items AE is different. That is, in the inspection route plan presentation step S4, creation of a plurality of the inspection route plans RP in which at least one of the inspection target apparatuses 2T or at least one of the inspection execution items AE is different is performed taking into account the damage risk RD and the inspection required time TR, and presentation of the plurality of inspection route plans RP that have been created is performed.

In the illustrated embodiment, the inspection route plan presentation step S4 is performed by an inspection route plan presentation unit 14. The inspection route plan presentation unit 14 is configured to be able to present the plurality of the inspection route plans RP in which at least one of the inspection target apparatuses 2T or at least one of the inspection execution items AE is different taking into account the damage risk RD and the inspection required time TR. The inspection route plan presentation unit 14 includes a creation unit 15 configured to create a plurality of the inspection route plans RP, each inspection route plan RP having at least one of the inspection target apparatuses 2T or at least one of the inspection execution items AE being different, taking into account the damage risk RD calculated by the damage risk calculation unit 12 and the inspection required time TR calculated by the inspection required time calculation unit 13, and a presentation unit 16 configured to present the plurality of inspection route plans RP created by the creation unit 15. The presentation unit 16 includes a display screen 161, and is configured to display the plurality of inspection route plans RP on the display screen 161.

In the above-described inspection route plan decision step S5, one inspection route plan RP selected from the plurality of inspection route plans RP presented in the inspection route plan presentation step S4 may be decided upon as the inspection route plan RP used for inspection.

According to the above method, in the inspection route plan presentation step S4, a plurality of the inspection route plans RP in which at least one of the inspection target apparatuses 2T or at least one of the inspection execution items AE is different are presented. Each of the plurality of inspection route plans RP presented in the inspection route plan presentation step S4 takes into account the damage risks RD and the inspection required times TR of the plurality of apparatuses 2. Therefore, by executing an inspection in accordance with one inspection route plan RP selected from the plurality of inspection route plans RP, it is possible to intensively inspect the apparatuses 2 having a damage risk RD that is high and to reduce excessive inspection costs.

### Inspection Route Plan Proposal System

The inspection route plan proposal system 10 according to some embodiments is for proposing the above-described inspection route plan RP. As illustrated in FIG. 2, the inspection route plan proposal system 10 at least includes the above-described inspection result information storage unit 11, the above-described damage risk calculation unit 12, the above-described inspection required time calculation unit 13, and the above-described inspection route plan presentation unit 14.

According to the above configuration, the inspection route plan presentation unit 14 presents the plurality of inspection route plans RP in which at least one of the inspection target apparatuses 2T or at least one of the inspection execution items AE is different. Each of the plurality of inspection route plans RP presented by the inspection route plan presentation unit 14 takes into account the damage risk RD and the inspection required time TR of each of the plurality of apparatuses 2. Therefore, by executing an inspection in accordance with one inspection route plan RP selected from the plurality of inspection route plans RP, the inspector can intensively inspect the apparatuses 2 having a damage risk RD that is high and reduce excessive inspection costs.

### Creation Method of Inspection Route Plan

As illustrated in FIG. 3, among the plurality of apparatuses 2 installed in the target inspection area 1, an apparatus preset as an inspection target is defined as a set apparatus 2S, and an apparatus having a damage risk equal to or higher than a predetermined risk other than the set apparatus 2S is defined as a high-risk apparatus 2H. Among the plurality of apparatuses 2 installed in the target inspection area 1, an apparatus having a damage risk less than a predetermined risk other than the set apparatus 2S is defined as a low-risk apparatus 2L.

In the illustrated embodiment, the set apparatus 2S includes an apparatus 2 in which the inspection interval is preset by law or the like. The high-risk apparatus 2H includes an apparatus 2 having a mean time between failures MTBF equal to or less than a predetermined mean time between failures (in the illustrated example, 10,000 hr/failure) other than the set apparatus 2S. The low-risk apparatus 2L includes an apparatus 2 having a mean time between failures MTBF exceeding a predetermined mean time between failures (in the illustrated example, 10,000 hr/failure) other than the set apparatus 2S.

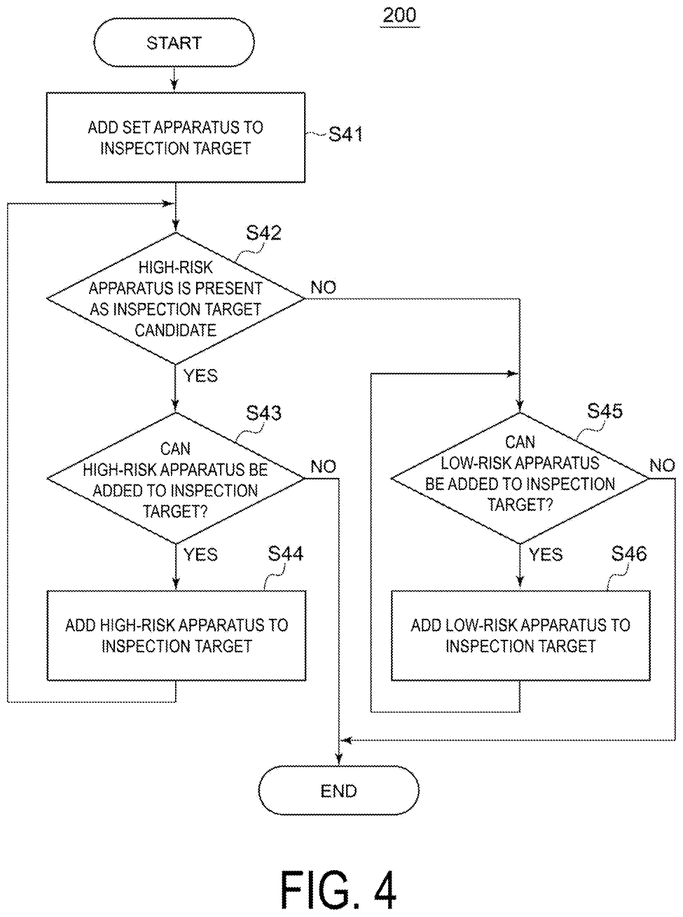

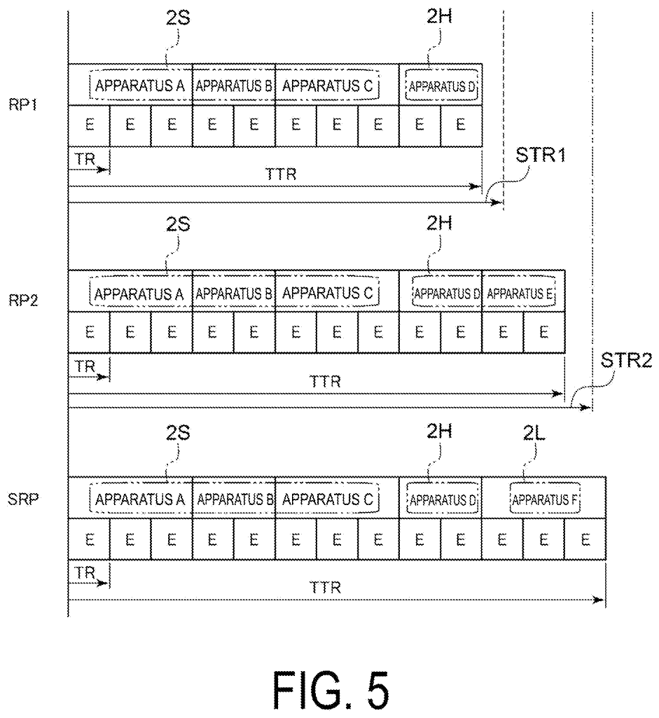

FIG. 4 is a flowchart of a creation method of an inspection route plan. FIG. 5 is an explanatory diagram for explaining an example of a creation method of an inspection route plan. In some embodiments, the creation unit 15 described above is configured to create each of the plurality of inspection route plans RP by a creation method 200 as illustrated in FIG. 4.

Specifically, the creation unit 15 adds all the set apparatuses 2S to the inspection target in the inspection route plan RP (S41). Next, the creation unit 15 determines whether a high-risk apparatus 2H not included in the inspection route plan RP (S42) is present, and, if a high-risk apparatus 2H is present (“YES” in S42), determines whether the high-risk apparatus 2H can be added to the inspection target (S43). The creation unit 15 may randomly extract a high-risk apparatus (determination target high-risk apparatus) 2H that is a determination target in S42 from among a plurality of high-risk apparatuses 2H, or may extract high-risk apparatuses 2H in descending order of risk.

Whether a high-risk apparatus (determination target high-risk apparatus) 2H can be added to the inspection target can be determined based on whether the total time in which the total of the inspection required times TR of all the inspection execution items AE included in the inspection route plan RP at the time of determination and the total of the inspection required times TR of the inspection execution items AE of the high-risk apparatus 2H are combined is equal to or less than a set required time STR that has been set in advance. If the total time is equal to or less than the set required time STR, the creation unit 15 determines that the high-risk apparatus 2H can be added to the inspection target (“YES” in S43), and adds the high-risk apparatus 2H to the inspection target (S44). If the total time exceeds the set required time STR, the creation unit 15 determines that the high-risk apparatus 2H cannot be added to the inspection target (“NO” in S43), and does not add the high-risk apparatus 2H to the inspection target.

The creation unit 15 determines whether the high-risk apparatus 2H not included in the inspection route plan RP (S42) is present, and, if the high-risk apparatus 2H is not present (“NO” in S42), determines whether a low-risk apparatus 2L can be added to the inspection target (S45). The creation unit 15 may randomly extract a low-risk apparatus (determination target low-risk apparatus) 2L that is a determination target in S45 from among a plurality of low-risk apparatuses 2L, or may extract low-risk apparatuses 2L in descending order of risk.

Whether a low-risk apparatus (determination target low-risk apparatus) 2L can be added to the inspection target can be determined based on whether the total time in which the total of the inspection required times TR of all the inspection execution items AE included in the inspection route plan RP at the time of determination and the total of the inspection required times TR of the inspection execution items AE of the low-risk apparatus 2L are combined is equal to or less than the set required time STR that has been set in advance. If the total time is equal to or less than the set required time STR, the creation unit 15 determines that the low-risk apparatus 2L can be added to the inspection target (“YES” in S45), and adds the low-risk apparatus 2L to the inspection target (S46). If the total time exceeds the set required time STR, the creation unit 15 determines that the low-risk apparatus 2L cannot be added to the inspection target (“NO” in S45), and does not add the low-risk apparatus 2L to the inspection target.

In some embodiments, when an apparatus preset as an inspection target is defined as the set apparatus 2S and an apparatus having a damage risk RD equal to or higher than a predetermined risk other than the set apparatus 2S is defined as a high-risk apparatus 2H among the plurality of apparatuses 2 described above, the above-described inspection route plan presentation unit 14 is configured to present, as one or more inspection route plans RP among the plurality of inspection route plans RP, a short-time route plan RP in which the total inspection required time TTR becomes equal to or less than the set required time STR, the short-time route plan RP in which the set apparatus 2S and one or more high-risk apparatuses 2H are the inspection target apparatuses 2T.

The creation unit 15 may be configured to create a plurality of the inspection route plans RP (RP1 and RP2) having total inspection required times TTR different from each other as illustrated in FIG. 5 by the creation method 200 described above. The creation unit 15 may be configured to create a first inspection route plan RP1 in which the total inspection required time TTR becomes equal to or less than a first set required time STR1 (STR), and a second inspection route plan RP2 in which the total inspection required time TTR exceeds the first set required time STR1 and becomes equal to or less than a second set required time STR2 (STR) longer than the first set required time STR1. Each of the first inspection route plan RP1 and the second inspection route plan RP2 includes the set apparatus 2S and one or more high-risk apparatuses 2H as the inspection target apparatuses 2T. The second set required time STR2 is set to be equal to inspection work available time, which is a time during which engagement in inspection work can be performed, or shorter than the inspection work available time.

According to the above configuration, by executing inspection in accordance with the short-time route plans RP1 and RP2, the inspector can perform inspection on both the set apparatus 2S and one or more of the high-risk apparatuses 2H having a damage risk RD that is high. Since the total inspection required time TTR of the short-time route plans RP1 and RP2 is equal to or less than the set required time STR, it is possible to suppress the time for engaging in the inspection work of the inspector who executes the inspection in accordance with the short-time route plans RP1 and RP2 from becoming a long time exceeding the set required time STR.

In some embodiments, the above-described inspection route plan presentation unit 14 may be configured to present, as one inspection route plan RP among the plurality of inspection route plans RP, the inspection route plan RP including the set apparatuses 2S and all the high-risk apparatuses 2H as the inspection target apparatuses 2T and not including the low-risk apparatus 2L. According to the above configuration, by performing the inspection in accordance with the inspection route plan RP including the set apparatus 2S and all the high-risk apparatuses 2H as the inspection target apparatuses 2T, the inspector performs appropriate inspection on all the high-risk apparatuses 2H, and therefore it is possible to improve the reliability of the plurality of apparatuses 2.

In some embodiments, the above-described inspection route plan presentation unit 14 may be configured to be able to further present a set inspection route plan SRP (see FIG. 5) set in advance, in addition to the plurality of inspection route plans RP. The set inspection route plan SRP is set in advance in, for example, a plant where the apparatuses 2 that are inspection targets are installed, or a plant of the same type as the plant. In FIG. 5, the total inspection required time TTR of the set inspection route plan SRP is longer than the total inspection required time TTR of the second inspection route plan RP2. The above configuration is useful for deciding the inspection route plan RP used for inspection since each of the plurality of inspection route plans RP can be compared with the set inspection route plan SRP.

### Individual Inspection Route Plan

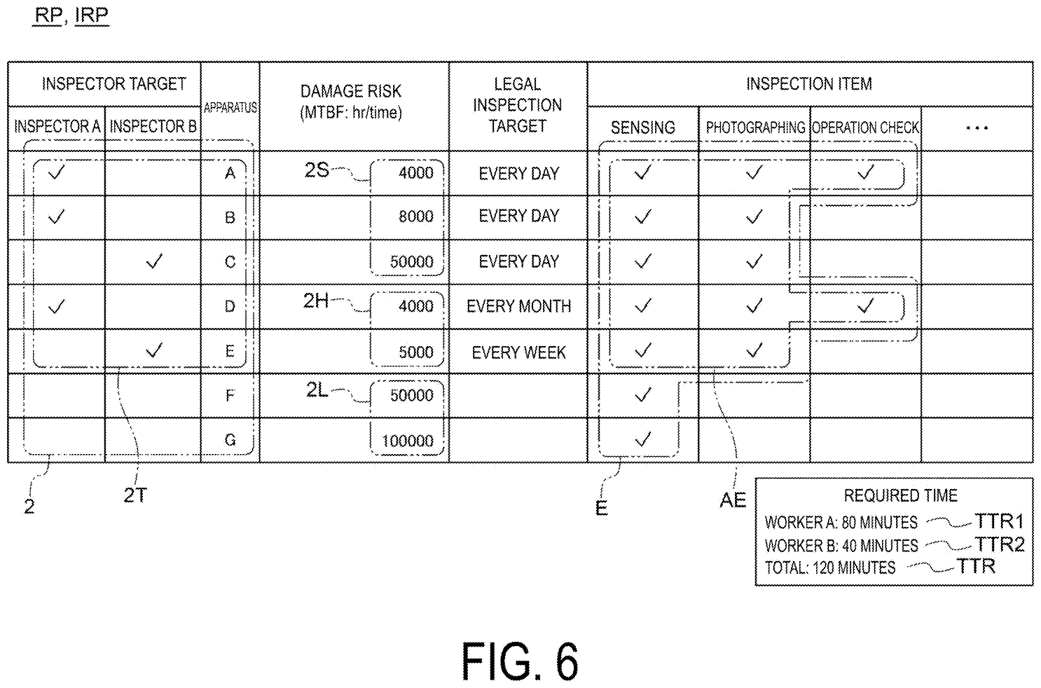

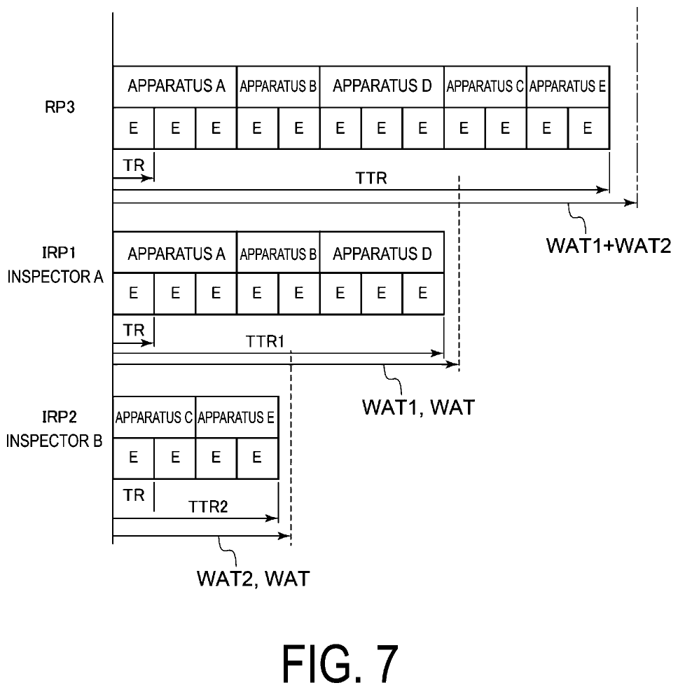

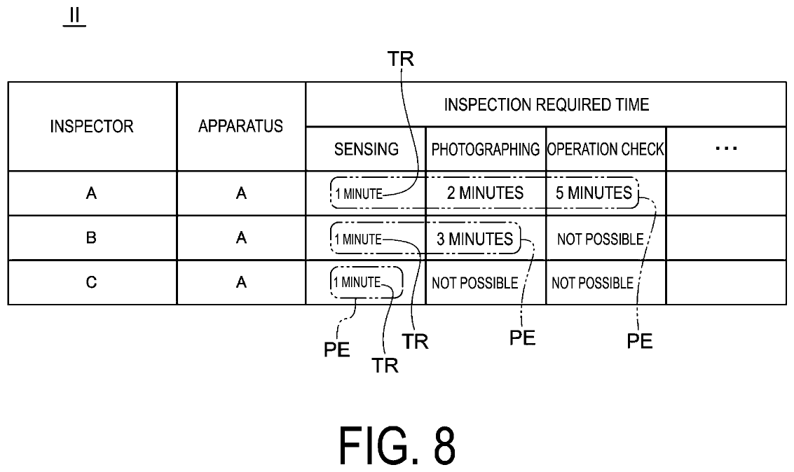

FIG. 6 is an explanatory diagram for explaining an inspection route plan according to one embodiment of the disclosure. FIG. 7 is an explanatory diagram for explaining an example of a creation method of an inspection route plan. FIG. 8 is an explanatory diagram for explaining information regarding an inspector.

In some embodiments, the above-described inspection route plan proposal system 10 further includes an inspector information storage unit 21 (see FIG. 2) that stores information II regarding an inspector who executes inspection of the inspection execution items AE for one or more of the inspection target apparatuses 2T. The above-described inspection route plan presentation unit 14 is configured to, when there are a plurality of inspectors, present an individual inspection route plan IRP for each of the inspectors, the individual inspection route plan IRP being the inspection route plan RP.

In the illustrated embodiment, the creation unit 15 described above is configured to create the plurality of individual inspection route plans IRP taking into account the information II regarding the inspectors stored in the inspector information storage unit 21. The information II regarding the inspectors includes information regarding the number of inspectors engaged in inspection as illustrated in FIG. 6. The creation unit 15 described above creates an inspection route plan RP3 in which the total inspection required time TTR becomes equal to or less than the total (in the illustrated example, WAT1+WAT2) of inspection work times of the plurality of inspectors as illustrated in FIG. 7 by the creation method 200 described above. Then, the creation unit 15 creates an individual inspection route plan IRP for each of the plurality of inspectors (IRP1 and IRP2) by distributing the inspection target apparatuses 2T and the inspection execution items AE included in the inspection route plan RP3 to each of the plurality of inspectors so as not to exceed the respective inspection work available times WAT (WAT1 and WAT2). Note that the creation unit 15 may directly create individual inspection route plans IRP (IRP1 and IRP2) in which the respective total inspection required times TTR (TTR1 and TTR2) become equal to or less than the respective inspection work available times WAT (WAT1 and WAT2).

According to the above configuration, the individual inspection route plans IRP presented by the inspection route plan presentation unit 14 are inspection route plans RP in which inspection execution items AE are allocated to each of the plurality of inspectors. By each of the plurality of inspectors executing inspection in accordance with the individual inspection route plans IRP, the inspection of a plurality of apparatuses 2 including the apparatuses 2 having a damage risk RD that is high is performed, and it is possible to suppress the time required for each inspector to perform inspection work from becoming long.

In some embodiments, as illustrated in FIG. 8, the information II regarding the inspector described above includes information indicating an inspectable item PE, which is an inspection item E of each of the plurality of apparatuses 2 that can be inspected by each inspector. The above-described inspection route plan presentation unit 14 is configured to present the individual inspection route plan IRP taking into account the information indicating the inspectable item PE.

Depending on the ability and experience of the inspector, the inspection items E for which the inspector can execute an appropriate inspection may differ. According to the above configuration, the individual inspection route plan IRP presented by the inspection route plan presentation unit 14 is the inspection route plan RP in which each of the inspectable items PE is allocated to each of the plurality of inspectors. In the individual inspection route plans IRP, inspection execution items AE that cannot be executed by an inspector with less ability and experience are allocated to an inspector with sufficient ability and experience. Therefore, in the individual inspection route plans IRP, appropriate inspection execution items AE are allocated according to the ability and experience of the inspectors. By each of the plurality of inspectors executing inspection in accordance with the individual inspection route plan IRP including the appropriate inspection execution items (inspectable items PE), appropriate inspection is performed on each of the plurality of apparatuses 2, and therefore the reliability of the plurality of apparatuses 2 can be improved.

In some embodiments, the above-described inspection result information storage unit 11 stores the inspectors and the inspection work times WT in association with each other, and the above-described inspection required time calculation unit 13 is configured to be able to calculate the inspection required time TR (see FIG. 8) for each inspector based on the inspection work times WT stored in the inspection result information storage unit 11. The inspection route plan presentation unit 14 described above is configured to present the individual inspection route plans IRP taking into account the inspection required time TR for each inspector.

The inspection work time WT for each inspection item E may differ depending on the ability and experience of the inspector. According to the above configuration, the individual inspection route plan IRP presented by the inspection route plan presentation unit 14 is the inspection route plan RP in which the inspection execution item AE is allocated to each of the plurality of inspectors taking into account the inspection required time TR for each inspector. In the individual inspection route plan IRP, since the inspection required time TR for each inspection item E tends to be shorter for an inspector with sufficient ability and experience than for an inspector with less ability and experience, many inspection execution items AE can be allocated. Therefore, in the individual inspection route plans IRP, appropriate inspection execution items AE are allocated according to the ability and experience of the inspectors. By each of the plurality of inspectors executing inspection in accordance with the individual inspection route plans IRP including appropriate inspection execution items AE, it is possible to suppress the time over which each inspector engages in inspection work from becoming excessively long or excessively short.

In some embodiments, the information II regarding the inspectors described above includes information indicating the inspection work available times WAT (see FIG. 7), which are times during which the inspectors can be engaged in inspection work. The above-described inspection route plan presentation unit 14 is configured to present the individual inspection route plan IRP taking into account the information indicating the inspection work available time WAT.

For example, the inspection work available times WAT, which are times during which engagement in inspection work can be performed, may differ among inspectors, such as in the case of a plurality of inspectors including a non-full-time inspector. According to the above configuration, the individual inspection route plans IRP presented by the inspection route plan presentation unit 14 take into account the inspection work available time WAT of each of the plurality of inspectors. The inspection items E are allocated to each of the plurality of inspectors such that the total inspection required time (TTR) falls within the inspection work available time WAT (WAT1 and WAT2). Since each of the plurality of inspectors executes inspection in accordance with the individual inspection route plan IRP including the inspection items E, it is possible to suppress the inspection work time WT of each of the plurality of inspectors from becoming a long time exceeding the inspection work available time WAT.

### Change of Inspection Route Plan at Time of Abnormality Determination

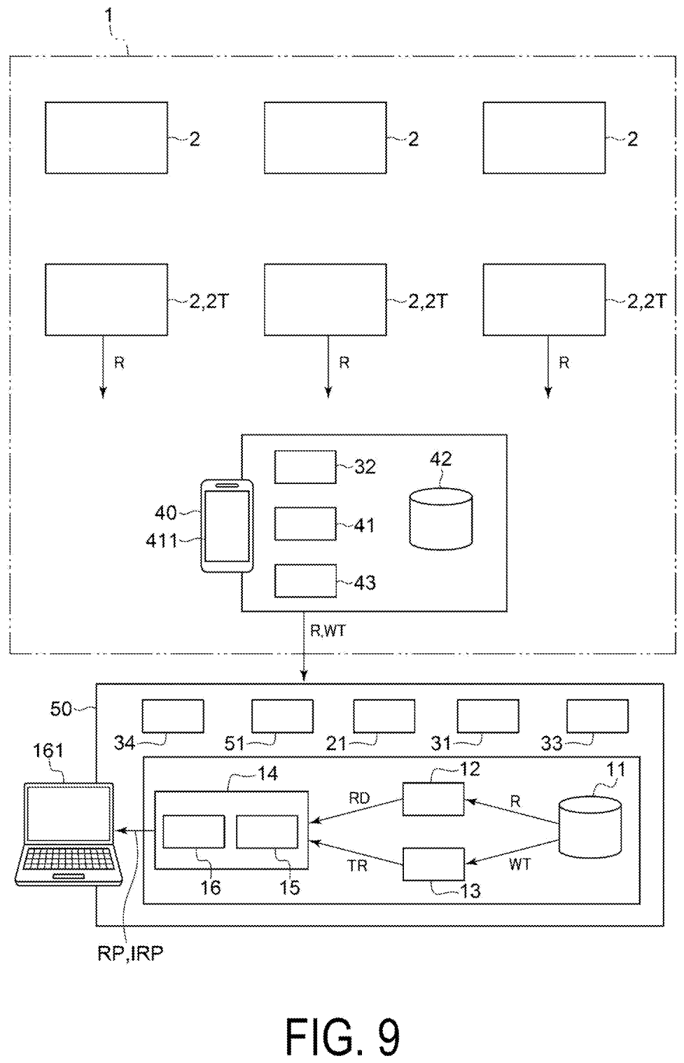

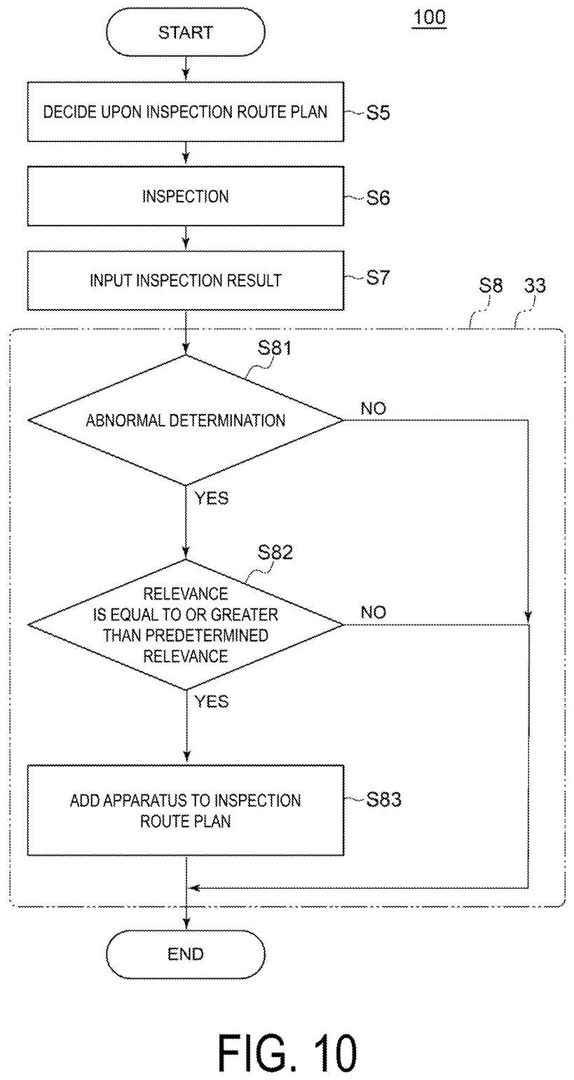

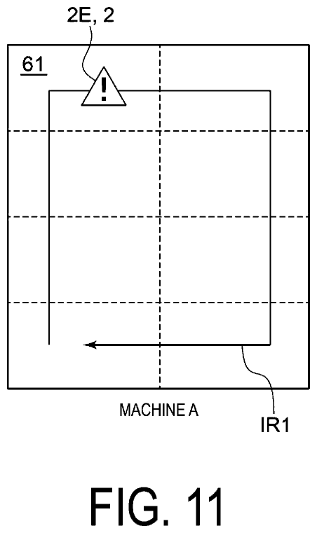

FIG. 9 is a schematic configuration diagram schematically illustrating the configuration of an inspection route plan proposal according to one embodiment of the disclosure. FIG. 10 is a flowchart of an inspection route plan proposal method according to one embodiment of the disclosure. Each of FIGS. 11 to 13 is an explanatory diagram for explaining an update of an inspection route plan at the time of abnormality determination. As illustrated in FIG. 10, the above-described inspection route plan proposal method 100 may, in a case where abnormality determination is input as an inspection result R in the inspection result information input step S7 (“YES” in S81), further include an inspection target apparatus addition step S8 of updating the inspection route plan RP to include the apparatus 2, of which a relevance to the apparatus 2 for which an abnormality determination is input is equal to or greater than a predetermined relevance, in an individual inspection route plan IRP different from the individual inspection route plan IRP for the inspector who has input the inspection result R.

In the illustrated embodiment, the inspection target apparatus addition step S8 is performed by an inspection result information input unit 32 (see FIG. 9). In some embodiments, as illustrated in FIG. 9, the above-described inspection route plan proposal system 10 further includes an apparatus relevance storage unit 31, the inspection result information input unit 32, and an inspection route plan update unit 33.

The apparatus relevance storage unit 31 stores a relevance indicating a degree of relationship among the plurality of apparatuses 2. Among the plurality of apparatuses 2, the relevance between the apparatuses 2 of the same or similar types is higher than the relevance between the apparatuses 2 of different types. Among the plurality of apparatuses 2, the relevance between the apparatuses 2 of the same or similar uses is higher than the relevance between the apparatuses 2 of different uses.

The inspection result information input unit 32 is configured to receive input of the inspection result R of each of the plurality of apparatuses 2 and the inspection work time WT for each inspection item E. The inspection results R and the inspection work times WT input via the inspection result information input unit 32 are stored in the inspection result information storage unit 11.

The inspection route plan update unit 33 is configured to update the inspection route plan RP so that, in a case where the abnormality determination is input as the inspection result R to the inspection result information input unit 32, an individual inspection route plan IRP different from the individual inspection route plan IRP for the inspector who has input the inspection result R includes the apparatus 2 (2R) that has a relevance to the apparatus 2 (2E) to which an abnormality determination is input equal to or greater than a predetermined relevance.

When abnormality determination is input as the inspection result R via the inspection result information input unit 32 (“YES” in S81), the inspection route plan update unit 33 determines whether there is the apparatus 2R that has a relevance to the apparatus 2E to which an abnormality determination is input equal to or greater than the predetermined relevance (S82). In the determination, when there is the apparatus 2R having a relevance equal to or greater than the predetermined relevance (“YES” in S82), the inspection route plan update unit 33 adds the apparatus 2R as the inspection target to an individual inspection route plan IRP different from the individual inspection route plan IRP in which the apparatus 2E is the inspection target (S83).

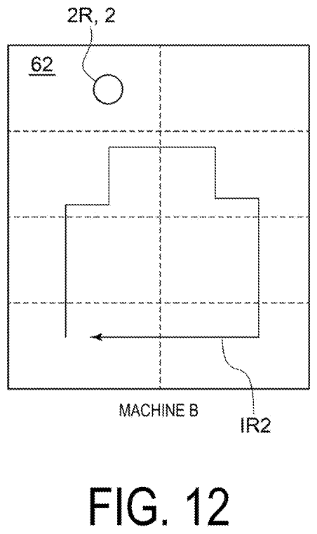

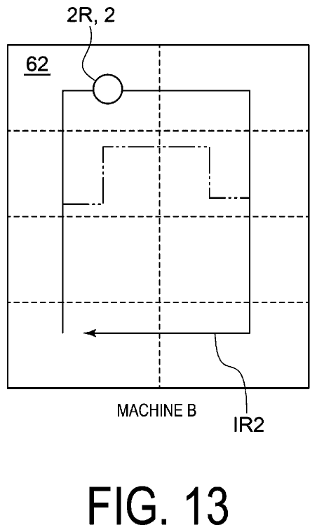

Hereinafter, specific examples will be described with reference to FIGS. 11 to 13. FIG. 11 illustrates the apparatus 2E to which an abnormality determination is input as the inspection result R via the inspection result information input unit 32 and a facility equipped with the apparatus 2E. The apparatus 2E is provided in one section 61 when the facility equipped with the apparatus 2E is divided into a plurality of sections. FIGS. 12 and 13 illustrate a facility of the same type as or similar type to the facility illustrated in FIG. 11 and the apparatus 2R provided in a section 62 corresponding to the section 61 when the facility is divided into a plurality of sections. Since the apparatus 2R is the same type of apparatus as the apparatus 2E and has the same use as that of the apparatus 2E, the relevance to the apparatus 2E is equal to or greater than a predetermined relevance. Here, the same type of facility includes facilities of the same type as the facility described above and installed at different places. A similar type of facility includes facilities of types different from the facility described above.

FIGS. 11 to 13 each illustrate inspection routes IR1 and IR2 in accordance with each inspection route plan. The apparatus 2R is not included in the inspection target before updating the inspection route plan including the facility illustrated in FIG. 12. In a case where an abnormality determination is made for the apparatus 2E illustrated in FIG. 11, as illustrated in FIG. 13, an apparatus 2R whose relevance to an apparatus 2E is equal to or greater than the predetermined relevance is added to the inspection target, and the inspection route IR2 is changed so as to pass through the apparatus 2R.

In the inspection, there is a high likelihood that a similar abnormality occurs in the apparatus 2 (2R) having a high relevance to the apparatus 2 (2E) in which the abnormality is detected. According to the above configuration, in the inspection route plan update unit 33, the apparatus 2 (2R) having a high relevance to the apparatus 2 (2E) in which the abnormality is detected can be included as the inspection target in the individual inspection route plan IRP for an inspector different from the inspector who has detected the abnormality of the apparatus 2 (2E). This allows the inspector to perform inspection of the apparatus 2 (2R) having the high relevance. According to the above configuration, since the inspection of the apparatus 2 (2R) having a high relevance to the apparatus 2 (2E) in which the abnormality is detected is promptly performed, the reliability of the plurality of apparatuses 2 can be improved.

### Customization of Inspection Route Plan

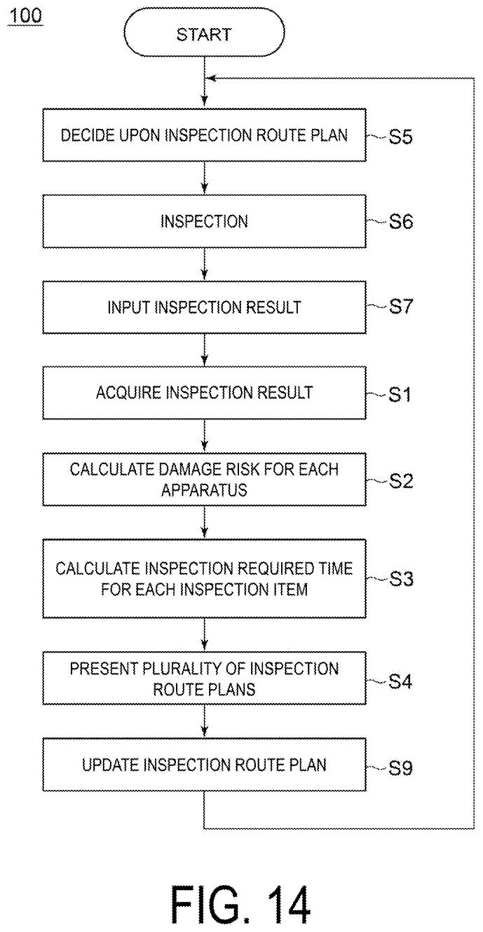

FIG. 14 is a flowchart of an inspection route plan proposal method according to one embodiment of the disclosure. As illustrated in FIG. 14, the above-described inspection route plan proposal method 100 may further include an inspection route plan update step S9 of adding or deleting at least one of the inspection target apparatuses 2T or the inspection execution items AE to or from one or more of the inspection route plans RP (including the individual inspection route plans IRP) presented in the inspection route plan presentation step S4. The inspection route plan update step S9 is performed prior to the inspection route plan decision step S5.

In the illustrated embodiment, the inspection route plan update step S9 is performed by an update route plan input unit 34 (see FIG. 9). In some embodiments, the above-described inspection route plan proposal system 10 further includes the update route plan input unit 34. The update route plan input unit 34 is configured to receive addition or deletion of at least one of the inspection target apparatuses 2T or the inspection execution items AE to or from the inspection route plan RP presented by the inspection route plan presentation unit 14.

The updated inspection route plan RP in which at least one of the inspection target apparatuses 2T or the inspection execution items AE is added or deleted via the update route plan input unit 34 is presented by the inspection route plan presentation unit 14. In the inspection route plan decision step S5, the inspection route plan RP (the inspection target apparatuses 2T and the inspection execution items AE) updated in the inspection route plan update step S9 (update route plan input unit 34) may be decided upon as the inspection route plan RP used for inspection.

According to the above configuration, with the update route plan input unit 34, the inspection route plan RP can be updated by adding or deleting, as necessary, the inspection target apparatuses 2T or the inspection execution items AE to or from the inspection route plan RP presented by the inspection route plan presentation unit 14. By including the update route plan input unit 34, the inspection route plan proposal system 10 can flexibly cope with a case where it is desired to change the inspection route plan RP.

In some embodiments, as illustrated in FIGS. 2 and 9, the above-described inspection route plan proposal system 10 further includes an information terminal 50. In the embodiment illustrated in FIGS. 2 and 9, the information terminal (display device) 50 includes the inspection result information storage unit 11, the damage risk calculation unit 12, the inspection required time calculation unit 13, the inspection route plan presentation unit 14, and the inspector information storage unit 21. In the embodiment illustrated in FIG. 9, the information terminal 50 further includes the apparatus relevance storage unit 31, the inspection route plan update unit 33, and the update route plan input unit 34. Note that in some other embodiments, at least one of the inspection result information storage unit 11, the damage risk calculation unit 12, the inspection required time calculation unit 13, the inspection route plan presentation unit 14, the inspector information storage unit 21, the apparatus relevance storage unit 31, the inspection route plan update unit 33, or the update route plan input unit 34 may be equipped in a device other than the information terminal 50 such as a mobile terminal 40, for example.

Each of the mobile terminal 40 and the information terminal 50 may be configured as a microcomputer including a processor (CPU) (not illustrated), a memory such as a ROM and a RAM, a storage device such as an external storage device, an I/O interface, and a communication interface. Then, each unit described above may be implemented by the CPU operating (for example, calculation of data or the like) in accordance with a command of a program loaded into a main storage device of the memory, for example.

In the illustrated embodiment, the display screen 161 for displaying the inspection route plan RP presented by the inspection route plan presentation unit 14 described above is provided in the information terminal 50.

In some embodiments, as illustrated in FIGS. 2 and 9, the above-described inspection route plan proposal system 10 further includes the mobile terminal 40. The mobile terminal 40 at least includes a display unit 41 configured to display the inspection route plan RP presented by the inspection route plan presentation unit 14, and the inspection result information input unit 32 configured to receive input of the inspection result R of each of the plurality of apparatuses 2 and the inspection work time WT for each inspection item E. The display unit 41 includes a display screen 411 provided on the mobile terminal 40, and is configured to display the plurality of inspection route plans RP on the display screen 411.

In the illustrated embodiment, the mobile terminal 40 is configured to be able to wirelessly communicate with the information terminal 50. The mobile terminal 40 includes a storage unit 42 that stores the inspection result R and the inspection work time WT input via the inspection result information input unit 32, and a communication unit 43 configured to be able to wirelessly communicate with a communication unit 51 of the information terminal 50. The information terminal 50 includes the communication unit 51 configured to be able to wirelessly communicate with the communication unit 43 of the mobile terminal 40. The inspection result R and the inspection work time WT input via the inspection result information input unit 32 are sent to the information terminal 50 via wireless communication between the communication unit 43 and the communication unit 51, and are stored in the inspection result information storage unit 11 of the information terminal 50. Note that the information terminal 50 may be provided outside the target inspection area 1.

According to the above configuration, by displaying the inspection route plan RP on the display unit 41 of the mobile terminal 40, the inspector can confirm the inspection route plan RP displayed on the display unit 41 at the time of inspection, and therefore it is possible to suppress inspection omission (omission of execution of the inspection execution item AE). By providing the mobile terminal 40 with the inspection result information input unit 32, the inspector can promptly input the inspection result R of each of the plurality of apparatuses 2 and the inspection work time WT for each inspection item E at the time of inspection.

The disclosure is not limited to the above-described embodiments, and includes embodiments obtained by modifying the above-described embodiments and embodiments obtained by appropriately combining these embodiments.

The contents of the embodiments described above can be understood as follows, for example.

(1) The inspection route plan proposal system (10) according to at least one embodiment of the disclosure is the inspection route plan proposal system (10) for proposing the inspection route plan (RP) for inspecting the plurality of apparatuses (2) installed in the target inspection area (1), the inspection route plan proposal system (10) including: the inspection result information storage unit (11) configured to store the inspection result (R) for each of the plurality of apparatuses (2) and the inspection work time (WT) for each inspection item (E); the damage risk calculation unit (12) configured to calculate the damage risk (RD) for each of the plurality of apparatuses (2) based on the inspection results (R) stored in the inspection result information storage unit (11); the inspection required time calculation unit (13) configured to calculate the inspection required time (TR) for each of the inspection items (E) of each of the plurality of apparatuses (2) based on the inspection work times (WT) stored in the inspection result information storage unit (11); and the inspection route plan presentation unit (14) that presents the inspection route plan (RP) including one or more inspection target apparatuses (2T) being an inspection target among the plurality of apparatuses (2), one or more inspection execution items (AE) being the inspection item (E) to be executed on the inspection target apparatus (2T), and the total inspection required time (TTR) required to execute inspection of the inspection execution item (AE) on the one or more inspection target apparatuses (2T), the inspection route plan presentation unit (14) being configured to be able to present a plurality of the inspection route plans (RP), each inspection route plan (RP) having at least one of the inspection target apparatuses (2T) or at least one of the inspection execution items (AE) being different, taking into account the damage risk (RD) and the inspection required time (TR).

According to the configuration in (1) above, the inspection route plan presentation unit (14) presents the plurality of inspection route plans (RP) in which at least one of the inspection target apparatuses (2T) or at least one of the inspection execution items (AE) is different. Each of the plurality of inspection route plans (RP) presented by the inspection route plan presentation unit (14) takes into account the damage risk (RD) and the inspection required time (TR) of each of the plurality of apparatuses (2). Therefore, by executing an inspection in accordance with one inspection route plan (RP) selected from the plurality of inspection route plans (RP), the inspector can intensively inspect the apparatus (2) having a damage risk (RD) that is high and to reduce an excessive inspection cost.

(2) In some embodiments, in the inspection route plan proposal system (10) according to (1) above, when the apparatus preset as the inspection target is defined as the set apparatus (2S), and the apparatus having the damage risk (RD) equal to or higher than a predetermined risk other than the set apparatus (2S) is defined as the high-risk apparatus (2H) among the plurality of apparatuses (2), the inspection route plan presentation unit (14) is configured to present, as one or more of the plurality of inspection route plans (RP) among the plurality of the inspection route plans, a short-time route plan (RP1 and RP2) in which the total inspection required time (TTR) is equal to or less than a set required time, and in which the set apparatus (2S) and one or more of the high-risk apparatuses (2H) are set as the inspection target apparatuses (2T).

According to the configuration in (2) above, by executing inspection in accordance with the short-time route plans (RP1) and (RP2), the inspector can perform inspection on both the set apparatus (2S) and one or more of the high-risk apparatuses (2H) having a damage risk (RD) that is high. Since the total inspection required time (TTR) of the short-time route plans (RP1) and (RP2) is equal to or less than the set required time, it is possible to suppress the time over which the inspector, who executes the inspection in accordance with the short-time route plans (RP1) and (RP2), engages in inspection work from becoming a long time exceeding the set required time.

(3) In some embodiments, the inspection route plan proposal system (10) according to (1) or (2) above, further includes the inspector information storage unit (21) that stores the information (II) regarding an inspector who executes inspection of the inspection execution item (AE) for the one or more inspection target apparatuses (2T), in which the inspection route plan presentation unit (14) is configured to, when there are a plurality of the inspectors, present an individual inspection route plan (IRP) for each of the inspectors, the individual inspection route plan (IRP) being the inspection route plan (RP).

According to the configuration in (3) above, the individual inspection route plan (IRP) presented by the inspection route plan presentation unit (14) is the inspection route plan (RP), in which the inspection execution item (AE) is allocated to each of the plurality of inspectors. By each of the plurality of inspectors executing inspection in accordance with the individual inspection route plan (IRP), the inspection of the plurality of apparatuses (2) including the apparatus (2) having a damage risk RD that is high is performed, and it is possible to suppress the time over which each of the plurality of inspectors engages in inspection work from becoming long.

(4) In some embodiments, in the inspection route plan proposal system (10) according to (3) above, the information (II) regarding the inspector includes information indicating the inspectable item (PE), which is the inspection item (E) of each of the plurality of apparatuses (2) that can be inspected by each of the inspectors, and the inspection route plan presentation unit (14) is configured to present the individual inspection route plan (IRP) taking into account information indicating the inspectable item (PE).

Depending on the ability and experience of the inspector, the inspection items (E) on which the inspector can execute an appropriate inspection may differ. According to the configuration in (4) above, the individual inspection route plan (IRP) presented by the inspection route plan presentation unit (14) is the inspection route plan (RP), in which the inspectable item (PE) is allocated to each of the plurality of inspectors. In the individual inspection route plan (IRP), an inspection execution item (AE) that cannot be executed by an inspector with less ability and experience is allocated to an inspector with sufficient ability and experience. Therefore, in the individual inspection route plan (IRP), an appropriate inspection execution item (AE) is allocated according to the ability and experience of the inspector. By each of the plurality of inspectors executing inspection in accordance with the individual inspection route plan (IRP) including the appropriate inspection execution item (inspectable item PE), appropriate inspection is performed on each of the plurality of apparatuses (2), and therefore the reliability of the plurality of apparatuses (2) can be improved.

(5) In some embodiments, in the inspection route plan proposal system (10) according to (3) or 4) above, the inspection result information storage unit (11) stores the inspectors and the inspection work times (WT) in association with each other, the inspection required time calculation unit (13) is configured to be able to calculate the inspection required time (TR) for each of the inspectors based on the inspection work times (WT) stored in the inspection result information storage unit (11), and the inspection route plan presentation unit (14) is configured to present the individual inspection route plan (IRP) taking into account the inspection required time (TR) for each of the inspectors.

The inspection work time (WT) for each inspection item may differ depending on the ability and experience of the inspector. According to the configuration in (5) above, the individual inspection route plan (IRP) presented by the inspection route plan presentation unit (14) is the inspection route plan (RP), in which the inspection execution item (AE) is allocated to each of the plurality of inspectors taking into account the inspection required time (TR) for each inspector. In the individual inspection route plan (IRP), since the inspection required time (TR) for each inspection item (E) tends to be shorter for an inspector with sufficient ability and experience than for an inspector with less ability and experience, many inspection execution items (AE) can be allocated. Therefore, in the individual inspection route plan (IRP), the appropriate inspection execution item (AE) is allocated according to the ability and experience of the inspector. By each of the plurality of inspectors executing an inspection in accordance with the individual inspection route plan (IRP) including the appropriate inspection execution item (AE), it is possible to suppress the time over which the inspector engages in inspection work from becoming excessively long or excessively short.

(6) In some embodiments, in the inspection route plan proposal system (10) according to any of (3) to (5) above, the information (II) regarding the inspectors includes information indicating the inspection work available time (WAT), which is time during which each of the inspectors can be engaged in the inspection work, and the inspection route plan presentation unit (14) is configured to present the individual inspection route plan (IRP) taking into account information indicating the inspection work available times (WAT).

For example, the inspection work available time (WAT), which is time during which engagement in the inspection work can be performed, may be differ among inspectors, such as in the case of a plurality of inspectors including a non-full-time inspector. According to the configuration in (6) above, the individual inspection route plan (IRP) presented by the inspection route plan presentation unit (14) takes into account the inspection work available time (WAT) of each of the plurality of inspectors. The inspection items (E) are allocated to each of the plurality of inspectors such that the total inspection required time (TTR) falls within the inspection work available time (WAT). Since each of the plurality of inspectors executes inspection in accordance with the individual inspection route plan (IRP) including the inspection items (E), it is possible to suppress the inspection work time (WT) of each of the plurality of inspectors from becoming a long time exceeding the inspection work available time (WAT).

(7) In some embodiments, the inspection route plan proposal system (10) according to any of 3) to 6) further includes: the apparatus relevance storage unit (31) that stores a relevance indicating a degree of relationship among the plurality of apparatuses (2); the inspection result information input unit (32) configured to receive input of the inspection result (R) for each of the plurality of apparatuses (2) and the inspection work time (WT) for each inspection item (E); and in a case where an abnormality determination is input as the inspection result to the inspection result information input unit (32), the inspection route plan update unit (33) configured to update the inspection route plan (RP) so that one of the apparatuses (2) whose relevance to another of the apparatuses (2) to which the abnormality determination is input is equal to or greater than a predetermined relevance is included in the individual inspection route plan (IRP) different from the individual inspection route plan (IRP) for the inspector who has input the inspection result (R).

In the inspection, there is a high likelihood that a similar abnormality occurs in the apparatus (2) having a high relevance to the apparatus (2) in which the abnormality is detected. According to the configuration in (7) above, in the inspection route plan update unit (33), the apparatus (2) having a high relevance to the apparatus (2) in which the abnormality is detected can be included as the inspection target in the individual inspection route plan (IRP) of the inspector different from the inspector who has detected the abnormality of the apparatus (2). This makes it possible to cause the inspector to perform inspection of the apparatus (2) having the high relevance. According to the configuration in (7), since the inspection of the apparatus (2) having a high relevance to the apparatus (2) in which the abnormality is detected is promptly performed, the reliability of the plurality of apparatuses (2) can be improved.

(8) In some embodiments, the inspection route plan proposal system (10) according to any of (1) to (7) above further includes: the update route plan input unit (34) configured to receive addition or deletion of at least one of the inspection target apparatuses (2T) or the inspection execution items (AE) to or from the inspection route plan (RP) presented by the inspection route plan presentation unit (14).

According to the configuration in (8) above, with the update route plan input unit (34), the inspection route plan (RP) can be updated by adding or deleting, as necessary, the inspection target apparatus (2T) or the inspection execution item (AE) to or from the inspection route plan (RP) presented by the inspection route plan presentation unit (14). By including the update route plan input unit (34), the inspection route plan proposal system (10) can flexibly cope with a case where it is desired to change the inspection route plan (RP).

(9) In some embodiments, the inspection route plan proposal system (10) according to any of (1) to (8) above further includes: the mobile terminal (40) that includes the display unit (41) configured to display the inspection route plan (RP) presented by the inspection route plan presentation unit (14), and the inspection result information input unit (32) configured to receive input of the inspection result (R) for each of the plurality of apparatuses (2) and the inspection work time (WT) for each inspection item (E).

According to the configuration in (9) above, by displaying the inspection route plan (RP) on the display unit (41) of the mobile terminal (40), the inspector can confirm the inspection route plan (RP) displayed on the display unit (41) at the time of inspection, and therefore it is possible to suppress inspection omission (omission of execution of the inspection execution item AE). By providing the mobile terminal (40) with the inspection result information input unit (32), the inspector can promptly input the inspection result (R) of each of the plurality of apparatuses (2) and the inspection work time (WT) for each inspection item (E) at the time of inspection.

(10) The inspection route plan proposal method (100) according to at least one embodiment of the disclosure is the inspection route plan proposal method (100) for proposing an inspection route plan (RP) for inspecting a plurality of apparatuses (2) installed in a target inspection area (1), the inspection route plan proposal method (100) comprising: an inspection result information acquisition step (S1) of acquiring an inspection result (R) for each of the plurality of apparatuses (2) and an inspection work time (WT) for each inspection item (E); a damage risk calculation step (S2) of calculating a damage risk (RD) for each of the plurality of apparatuses (2) based on the inspection results (R) acquired in the inspection result information acquisition step (S1); an inspection required time calculation step (S3) of calculating an inspection required time (TR) for each of the inspection items (E) of each of the plurality of apparatuses (2) based on the inspection work time (WT) acquired in the inspection result information acquisition step (S1); and an inspection route plan presentation step (S4) of presenting an inspection route plan (RP) including one or more inspection target apparatuses (2T) being an inspection target among the plurality of apparatuses (2), one or more inspection execution items (AE) being the inspection item (E) to be executed on the inspection target apparatus (2T), and a total inspection required time (TTR) required to execute inspection of the inspection execution item (AE) on the one or more inspection target apparatuses (2T), the inspection route plan presentation step (S4) of presenting a plurality of the inspection route plans (RP), each inspection route plan (RP) having at least one of the inspection target apparatuses (2T) or at least one of the inspection execution items (AE) being different, taking into account the damage risk (RD) and the inspection required time (TR).

According to the method of (10) above, in the inspection route plan presentation step (S4), the plurality of inspection route plans (RP) in which at least one of the inspection target apparatuses (2T) or at least one of the inspection execution items (AE) is different are presented. Each of the plurality of inspection route plans (RP) presented in the inspection route plan presentation step (S4) takes into account the damage risk (RD) and the inspection required time (TR) of each of the plurality of apparatuses (2). Therefore, by executing an inspection in accordance with one inspection route plan (RP) selected from the plurality of inspection route plans (RP), it is possible to intensively inspect the apparatus (2) having a damage risk (RD) that is high and to reduce excessive inspection costs.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. An inspection route plan proposal system for proposing an inspection route plan for inspecting a plurality of apparatuses installed in a target inspection area, the inspection route plan proposal system comprising:
an inspection result information storage unit configured to store an inspection result for each of the plurality of apparatuses and an inspection work time for each inspection item;
a damage risk calculation unit configured to calculate a damage risk for each of the plurality of apparatuses based on the inspection results stored in the inspection result information storage unit;
an inspection required time calculation unit configured to calculate an inspection required time for each of the inspection items of each of the plurality of apparatuses based on the inspection work times stored in the inspection result information storage unit; and
an inspection route plan presentation unit that presents an inspection route plan including one or more inspection target apparatuses being an inspection target among the plurality of apparatuses, one or more inspection execution items being the inspection item to be executed on the inspection target apparatus, and a total inspection required time required to execute inspection of the inspection execution item on the one or more inspection target apparatuses, the inspection route plan presentation unit being configured to be able to present a plurality of the inspection route plans, each inspection route plan having at least one of the inspection target apparatuses or at least one of the inspection execution items being different, taking into account the damage risk and the inspection required time.

2. The inspection route plan proposal system according to claim 1, wherein
when the apparatus preset as the inspection target is defined as a set apparatus, and the apparatus having the damage risk equal to or higher than a predetermined risk other than the set apparatus is defined as a high-risk apparatus among the plurality of apparatuses,
the inspection route plan presentation unit is configured to present, as one or more of the inspection route plans among the plurality of the inspection route plans, a short-time route plan in which the total inspection required time is equal to or less than a set required time, and in which the set apparatus and one or more of the high-risk apparatuses are set as the inspection target apparatuses.

3. The inspection route plan proposal system according to claim 1 further comprising:
an inspector information storage unit that stores information regarding an inspector who executes inspection of the inspection execution item for the one or more inspection target apparatuses, wherein
the inspection route plan presentation unit is configured to, when there are a plurality of the inspectors, present an individual inspection route plan for each of the inspectors, the individual inspection route plan being the inspection route plan.

4. The inspection route plan proposal system according to claim 3, wherein
information regarding the inspector includes information indicating an inspectable item, which is the inspection item of each of the plurality of apparatuses that can be inspected by each of the inspectors, and
the inspection route plan presentation unit is configured to present the individual inspection route plan taking into account information indicating the inspectable item.

5. The inspection route plan proposal system according to claim 3, wherein
the inspection result information storage unit stores the inspectors and the inspection work times in association with each other,
the inspection required time calculation unit is configured to be able to calculate the inspection required time for each of the inspectors based on the inspection work times stored in the inspection result information storage unit, and
the inspection route plan presentation unit is configured to present the individual inspection route plan taking into account the inspection required time for each of the inspectors.

6. The inspection route plan proposal system according to claim 3, wherein
information regarding the inspectors includes information indicating inspection work available time, which is time during which each of the inspectors can be engaged in inspection work, and
the inspection route plan presentation unit is configured to present the individual inspection route plan taking into account information indicating the inspection work available times.

7. The inspection route plan proposal system according to claim 3 further comprising:
an apparatus relevance storage unit that stores a relevance indicating a degree of relationship among the plurality of apparatuses;
an inspection result information input unit configured to receive input of an inspection result for each of the plurality of apparatuses and an inspection work time for each inspection item; and
in a case where an abnormality determination is input as the inspection result to the inspection result information input unit, an inspection route plan update unit configured to update the inspection route plan so that one of the apparatuses whose relevance to another of the apparatuses to which the abnormality determination is input is equal to or greater than a predetermined relevance is included in the individual inspection route plan different from the individual inspection route plan for the inspector who has input the inspection result.

8. The inspection route plan proposal system according to claim 1 further comprising:
an update route plan input unit configured to receive addition or deletion of at least one of the inspection target apparatuses or the inspection execution items to or from the inspection route plan presented by the inspection route plan presentation unit.

9. The inspection route plan proposal system according to claim 1 further comprising:
a mobile terminal that includes a display unit configured to display the inspection route plan presented by the inspection route plan presentation unit, and an inspection result information input unit configured to receive input of an inspection result for each of the plurality of apparatuses and an inspection work time for each inspection item.

10. An inspection route plan proposal method for proposing an inspection route plan for inspecting a plurality of apparatuses installed in a target inspection area, the inspection route plan proposal method comprising:
an inspection result information acquisition step of acquiring an inspection result for each of the plurality of apparatuses and an inspection work time for each inspection item;
a damage risk calculation step of calculating a damage risk for each of the plurality of apparatuses based on the inspection results acquired in the inspection result information acquisition step;
an inspection required time calculation step of calculating an inspection required time for each of the inspection items of each of the plurality of apparatuses based on the inspection work time acquired in the inspection result information acquisition step; and
an inspection route plan presentation step of presenting an inspection route plan including one or more inspection target apparatuses being an inspection target among the plurality of apparatuses, one or more inspection execution items being the inspection item to be executed on the inspection target apparatus, and a total inspection required time required to execute inspection of the inspection execution item on the one or more inspection target apparatuses, the inspection route plan presentation step of presenting a plurality of the inspection route plans, each inspection route plan having at least one of the inspection target apparatuses or at least one of the inspection execution items being different, taking into account the damage risk and the inspection required time.
